(19) United States
(12) Patent Application Publication
(10) Pub. No.: US 2010/0058460 A1
(43) Pub. Date: Mar. 4, 2010

(54) SYSTEM AND METHOD FOR AUTHENTICATING AN END USER

(75) Inventors: Christian Kaiser, Arnsberg (DE); Thomas Prause, Rottenburg (DE)

Correspondence Address: Greg Goshorn, P.C., 9600 Escarpment, Suite 745-9, AUSTIN, TX, 78749, US

(73) Assignee: INTERNATIONAL BUSINESS MACHINES CORPORATION, Armonk, NY (US)

(21) Appl. No.: 12/200,104

(22) Filed: Aug. 28, 2008

(51) Int. Cl. G06F 21/00

(52) U.S. Cl. 726/16

(57) ABSTRACT

A method for authenticating an end user. The method comprising receiving a first userID and a first password from an end user. Next, attempting to authenticate the end user using the first userID and the first password provided. Finally, sending an error message to the end user in response to failing to authenticate the end user using the first userID and the first password wherein the error message comprises a first option and a second option. The first option comprising a first key combination that if entered would allow the end user to enter a second password and authenticate using the first userID and the second password. The second option comprising a second key combination that if entered would allow the end user to enter a second userID and a third password and authenticate using the second UserID and the third password.

### BACKGROUND OF THE INVENTION

The present invention relates generally to end user authentication, and more particularly to preserving the integrity of an end user's password in the event of a failed authentication attempt.

Conventional authentication methods require an end user to provide both a unique user identification (hereinafter userID) and password combination in order to access secure information. Many institutions require ever more complicated userID and password combinations in an effort to thwart identity theft. Additionally, conventional methods of authenticating an end user display the userID in plaintext while obfuscating the password.

In light of utilizing ever more complicated userID and password combinations, there is a greater chance an end user will incorrectly enter the end user's userID and password combination during an authentication attempt. Should an authentication attempt fail, and end user is prompted to re-enter the end user's userID and password. An end user may simply re-enter the end user's password when prompted for their userID, thus exposing the end user's password in plaintext.

### SUMMARY OF THE INVENTION

The present invention provides a method for authenticating an end user, said method comprising:

receiving a first userID from an end user, said receiving said first userID being in response to requesting said first userID from said end user;

after said receiving said first userID, receiving a first password from said end user, said receiving said first password being in response to requesting said first password from said end user; and

sending an error message to said end user, said sending said error message being in response to failing to authenticate said end user using said first userID and said first password, said error message comprising a first option and a second option, said first option comprising a first key combination that if entered would allow said end user to enter a second password and authenticate using said first userID and said second password, said second option comprising a second key combination that if entered would allow said end user to enter a second userID and a third password and authenticate using said second UserID and said third password.

### BRIEF DESCRIPTION OF THE DRAWINGS

FIG. 1 illustrates a conventional method for authenticating an end user.

FIG. 2 illustrates a method for authenticating an end user, in accordance with embodiments of the present invention.

FIG. 3 illustrates the information flow between the present invention and an end user during an authentication attempt, in accordance with embodiments of the present invention.

FIG. 4 illustrates a computer system which may facilitate a method for authenticating an end user, in accordance with embodiments of the present invention.

### DETAILED DESCRIPTION OF THE DRAWINGS

Although certain embodiments of the present invention are described herein, it is understood modifications may be made to the present invention without departing from its course and scope. Scope of the present invention is not limited to the number of constituting components, the materials thereof, the shapes thereof, the relative arrangement thereof, etc. Furthermore, while the accompanying drawings illustrate certain embodiments of the present invention, such drawings are not necessarily depicted to scale.

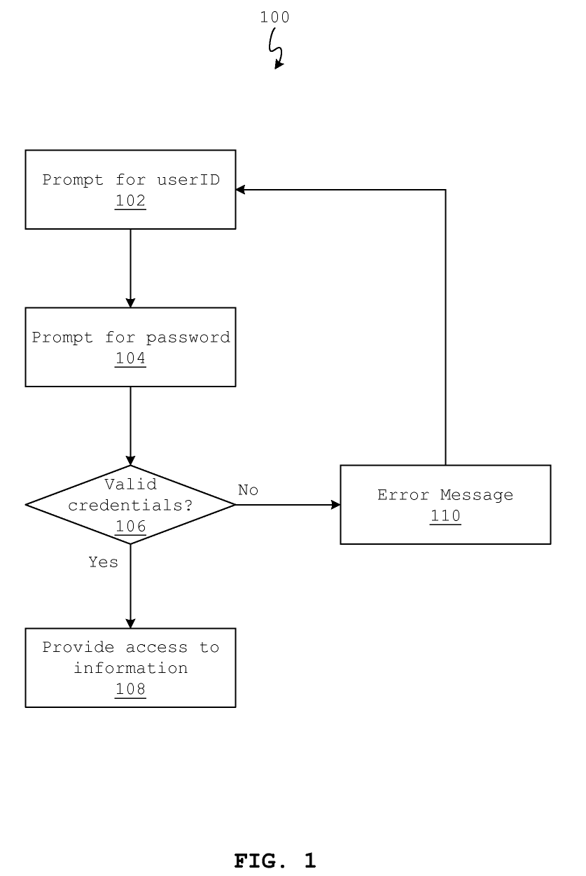

FIG. 1 illustrates a conventional method 100 for authenticating an end user. The conventional method 100 begins with step 102 which prompts an end user for both the end user's userID and password.

Step 102 prompts an end user for their userID. Conventionally, step 102 submits the prompt to an output device, traditionally a computer screen. After prompting the end user, step 102 waits for receipt of the end user's userID. Conventionally the userID provided by the end user is displayed on the output device in plaintext. After receipt of the end user's userID, the method 100 continues with step 104 which prompts the end user for their password.

Step 104 prompts the end user for their password. Conventionally the userID provided by the end user obfuscated on the output device when entered. Obfuscating the end user's password prevents a third party from observing the end user's userID and password combination, thus gaining the ability to access the end user's protected information stored by the system utilizing the conventional method 100. After receiving the end user's password, the method 100 continues with step 106 which determines the validity of the end user's userID and password.

Step 106 determines the validity of the userID and password combination received in steps 102 and 104, supra. Conventionally, step 106 compares the userID received in step 102 with each userID residing within the system utilizing the conventional method 100 for authenticating an end user.

Should step 106 fail to locate a userID within the system utilizing the conventional method 100 matching the userID received in step 102, the authentication attempt fails and the method 100 continues with step 110 which sends an error message to the end user.

However, should step 106 locate a userID within the system utilizing the conventional method 100 matching the userID received in step 102, step 106 compares the password provided in step 104 with the password associated with the userID located in the system.

Should the password received in step 104 match the password located in the system, the method 100 continues with step 108 which provides the end user access to protected information.

However, if step 106 determines the password provided in step 104 and the password located in the system do not match, step 106 ends and the method 100 continues with step 110 which sends an error message to the end user.

Step 110 sends an error message to the end user via the output device, conventionally a computer screen. After sending the error message to the end user, the step 110 ends and the method 100 returns to step 102 which prompts the end user for the end user's userID again.

A problem with the conventional method 100 is that an end user may view the error message displayed in step 110 and re-enter the end user's password instead of the end user's userID when the method 100 returns to step 102. Since step 102 displays the requested userID in plaintext, when the end user provides the end user's password to step 102, the password is thereinafter displayed in plaintext. The end user's password displayed in plaintext is easily observed by the third party and thus gaining the ability to access the end user's protected information stored by the system utilizing the conventional method 100.

Another problem with the conventional method 100 is that after sending the end user the error message 110, the method 100 may pause for a period of time before continuing back to step 102 and prompting for the userID. An end user reacting too quickly to the error message 110 may re-enter their userID during the pause period, the result of which is that the method 100 does nothing with the re-entered userID. When the method 100 finally returns to step 102 and prompts for the end user's userID, the end user will believe they have already submitted their userID and now inadvertently enter their password. The password being sent in response to the prompt for the userID would therefore be displayed in plaintext for all to see.

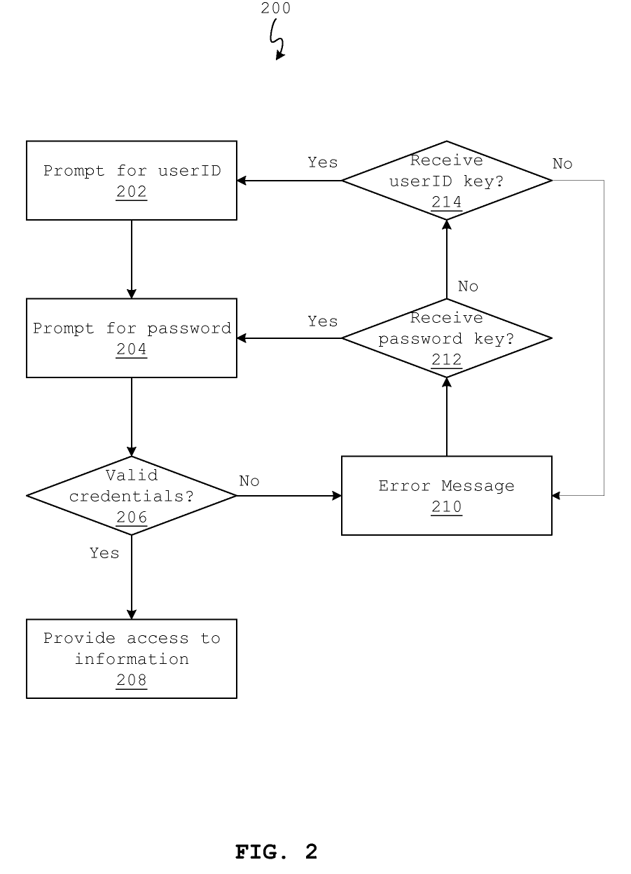

FIG. 2 illustrates a method 200 for authenticating an end user, in accordance with embodiments of the present invention. The method 200 begins with step 202 which prompts an end user for their userID.

Step 202 prompts an end user for the end user's userID by sending the request to an output device. After prompting the end user, step 202 waits for receipt of the end user's userID. The userID provided by the end user is displayed on the output device by the method 200 in plaintext. After receipt of the end user's userID, the method 200 continues with step 204 which prompts the end user for their password.

Step 204 prompts the end user for the end user's password by sending the request to the output device. After prompting the end user, step 204 waits for receipt of the end user's password. The password provided by the end user is obfuscated when sent to the output device in order to prevent a third party from observing the end user's password, and thus gaining the ability to access the end user's protected information stored by the system utilizing the method 200. After receiving the end user's password, the method 200 continues with step 206 which determines the validity of the end user's userID and password.

Step 206 determines the validity of the userID and password combination received in steps 202 and 204, supra. Step 206 compares the userID received in step 202 with each userID residing within the system utilizing the method 200 for authenticating an end user.

Should step 206 fail to locate a userID within the system utilizing the method 200 matching the userID received in step 202, the authentication attempt fails and the method 200 continues with step 210 which sends an error message to the end user.

However, should step 206 locate a userID within the system utilizing the method 200 matching the userID received in step 202, step 206 compares the password provided in step 204 with the password associated with the userID located in the system.

Should the password received in step 204 match the password located in the system, the method 200 continues with step 208 which provides the end user access to protected information.

However, if step 206 determines the password provided in step 204 and the password located in the system do not match, step 206 ends and the method 200 continues with step 210 which sends an error message to the end user.

Step 210 sends an error message to the end user via the output device. The error message comprises a notification that the attempted authentication failed and offers the end user two options and specific key combinations for initiating each option. One option is to re-enter only the password, utilizing the userID previously provided in a subsequent attempt to authenticate the end user. This option, if selected by the end user, would return the method 200 to step 204 to prompt for the end user's password.

Another option is to re-enter both the userID and password in a new attempt to authenticate the end user. This option, if selected by the end user, would return the method 200 to step 202 to prompt for the end user's userID.

After sending the error message to the output device, step 210 awaits a key combination. Upon receipt of a key combination, the method 200 continues with step 212 which determines if the key combination provided corresponds to the option to re-enter only the password.

Step 212 compares the key combination provided by the end user and the key combination required to return to step 204 allowing the end user to re-enter their password. If the key combination provided matches the key combination necessary to return the method 200 to step 204, the method 200 therein continues with step 204 which prompts the end user for their password.

However, if the key combination provided by the end user not match the key combination necessary to return the method 200 to step 204, the method 200 continues to step 214 which determines if the key combination provided corresponds to the option to re-enter both the end user's userID and password.

Step 214 compares the key combination provided by the end user and the key combination required to return to step 202 allowing the end user to re-enter their userID. If the key combination provided matches the key combination necessary to return the method 200 to step 202, the method 200 therein continues with step 202 which prompts the end user for their userID.

However, if the key combination provided by the end user not match the key combination necessary to return the method 200 to step 202, the method 200 continues to step 210 which sends an error message to the end user.

In an alternative embodiment of the present invention, the method 200 further comprises a counter to determine the number of times a specific end user proceeds to step 210 having failed to properly authenticate to the system utilizing the method 200. Each instance of step 210 increments a counter until a threshold value is reached exceeded, said threshold being provided by an end user administering the system.

After the counter's value equals and/or exceeds the threshold value, the method 200 prevents the end user attempting to authenticate from entering the end user's userID or password for a period of time. The period of time also being provided by the end user administering the system. After the period of time has elapsed, the method 200 would return to step 202 and prompt the end user attempting to authenticate for their userID.

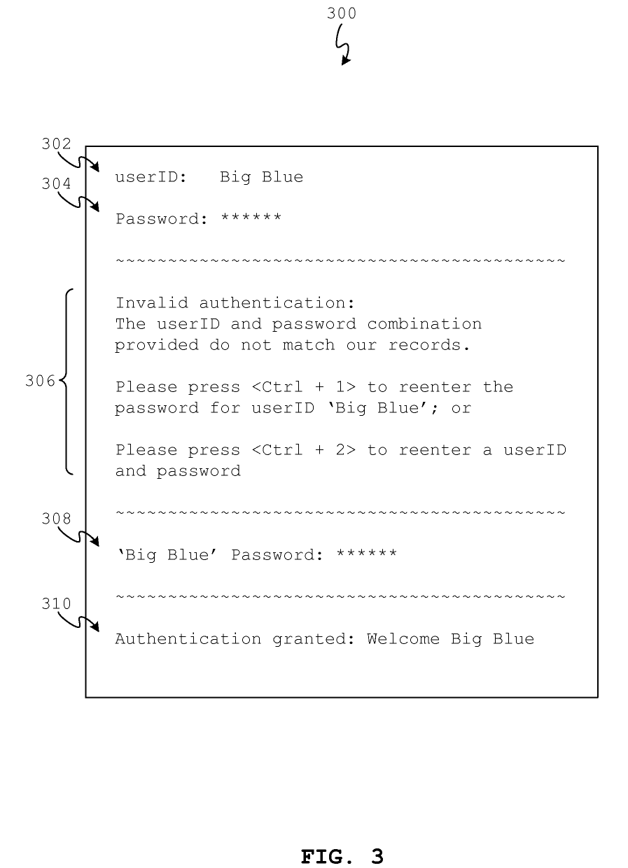

FIG. 3 illustrates the information flow 300 between the present invention and an end user during an authentication attempt, in accordance with embodiments of the present invention.

The information flow 300 starts with 302 where the system prompts the end user for their userID. 302 is a graphical representation of step 202 (see FIG. 2, supra). The end user attempting to authenticate thereinafter entered their userID, which in the example depicted in FIG. 3 the userID is ‘Big Blue’.

After prompting the end user for their userID, the flow 300 continues with 304 where the system prompts the end user for their password. 304 is a graphical representation of step 204 (see FIG. 2, supra). The end user thereinafter entered their password, which in the example depicted in FIG. 3 is obfuscated by the asterisk (*) characters to prevent a third party from viewing the end user's password in plaintext.

After prompting the end user for their password, the flow 300 attempts to validate the end user's credentials and in the example depicted in FIG. 3, the credentials provided are incorrect and the flow 300 prompts the end user with an error message 306. 306 is an example of the error message sent to an output device in step 210 (see FIG. 2, supra). 306 notifies the end user the end user's userID and password combination are incorrect and provides the end user with two options: 1) press the key combination <Ctrl+1> to re-enter only the end user's password; or 2) press the key combination <Ctrl+2> to re-enter both the end user's userID and password. In one embodiment of the present invention, the first option allowing the end user to re-enter just the end user's password contains the userID as provided by the end user with respect to 302 and step 202 (see FIG. 2, supra). The inclusion of the provided userID allows the end user to visually determine if the userID provided was entered correctly.

After prompting the end user with the error message 306, the flow 300 receives a key combination and in the example depicted in FIG. 3, the end user entered the first option (key combination <Ctrl+1>) which therein prompts the end user for only the end user's password 308. The end user again enters the end user's password obfuscated by asterisk characters.

After re-prompting the end user for the end user's password and receiving the end user's password, the flow 300 attempts to authenticate the end user utilizing the userID provided in response to prompt 302 and the password provided in response to prompt 308. In the example depicted in FIG. 3, the userID and password combination are valid and the flow 300 continues with a prompt 310 notifying the end user of the valid authentication.

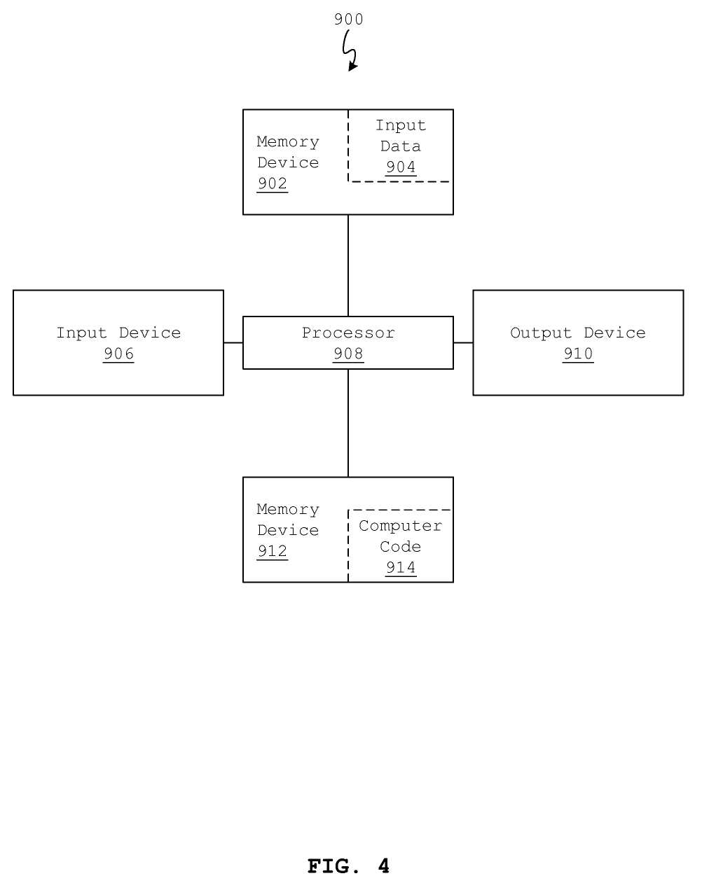

FIG. 4 illustrates a computer system 900 which may facilitate a method for authenticating an end user, in accordance with embodiments of the present invention.

The computer system 900 comprises a processor 908, an input device 906 coupled to the processor 908, an output device 910 coupled to the processor 908, and memory devices 902 and 912 each coupled to the processor 908.

The input device 906 may be, inter alia, a keyboard, a mouse, a keypad, a touchscreen, a voice recognition device, a sensor, a network interface card (NIC), a Voice/video over Internet Protocol (VOIP) adapter, a wireless adapter, a telephone adapter, a dedicated circuit adapter, etc.

The output device 910 may be, inter alia, a printer, a plotter, a computer screen, a magnetic tape, a removable hard disk, a floppy disk, a NIC, a VOIP adapter, a wireless adapter, a telephone adapter, a dedicated circuit adapter, an audio and/or visual signal generator, a light emitting diode (LED), etc.

The memory devices 902 and 912 may be, inter alia, a cache, a dynamic random access memory (DRAM), a read-only memory (ROM), a hard disk, a floppy disk, a magnetic tape, an optical storage such as a compact disc (CD) or a digital video disc (DVD), etc. The memory device 912 includes a computer code 914 which is a computer program that comprises computer-executable instructions.

The computer code 914 includes, inter alia, an algorithm used for authenticating an end user according to the present invention. The processor 908 executes the computer code 914. The memory device 902 includes input data 904. The input data 904 includes input required by the computer code 914. The output device 910 displays output from the computer code 914. Either or both memory devices 902 and 912 (or one or more additional memory devices not shown in FIG. 4) may be used as a computer usable medium (or a computer readable medium or a program storage device) having a computer readable program embodied therein and/or having other data stored therein, wherein the computer readable program comprises the computer code 914. Generally, a computer program product (or, alternatively, an article of manufacture) of the computer system 900 may comprise said computer usable medium (or said program storage device).

Any of the components of the present invention can be deployed, managed, serviced, etc. by a service provider that offers to deploy or integrate computing infrastructure with respect to a process for authenticating an end user. Thus, the present invention discloses a process for supporting computer infrastructure, comprising integrating, hosting, maintaining and deploying computer-readable code into a computing system (e.g., computing system 900), wherein the code in combination with the computing system is capable of performing a method for authenticating an end user.

In another embodiment, the invention provides a business method that performs the process steps of the invention on a subscription, advertising and/or fee basis. That is, a service provider, such as a Solution Integrator, can offer to create, maintain, support, etc. a process for authenticating an end user. In this case, the service provider can create, maintain, support, etc. a computer infrastructure that performs the process steps of the invention for one or more customers. In return, the service provider can receive payment from the customer(s) under a subscription and/or fee agreement, and/or the service provider can receive payment from the sale of advertising content to one or more third parties.

While FIG. 4 shows the computer system 900 as a particular configuration of hardware and software, any configuration of hardware and software, as would be known to a person of ordinary skill in the art, may be utilized for the purposes stated supra in conjunction with the particular computer system 900 of FIG. 4. For example, the memory devices 902 and 912 may be portions of a single memory device rather than separate memory devices.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed:

1. A method for authenticating an end user, said method comprising:
receiving a first userID from an end user, said receiving said first userID being in response to requesting said first userID from said end user;
after said receiving said first userID, receiving a first password from said end user, said receiving said first password being in response to requesting said first password from said end user; and
sending an error message to said end user, said sending said error message being in response to failing to authenticate said end user using said first userID and said first password, said error message comprising a first option and a second option, said first option comprising a first key combination that if entered would allow said end user to enter a second password and authenticate using said first userID and said second password, said second option comprising a second key combination that if entered would allow said end user to enter a second userID and a third password and authenticate using said second UserID and said third password.

2. The method of claim 1, said error message further comprising said first userID thereby identifying for said end user whether said first userID was entered properly by said end user.

3. The method of claim 1, said method further comprising:
receiving said second password from said end user, said receiving said second password being in response to requesting said second password from said end user, said requesting said second password being in response to receiving said first key combination from said end user, and
authenticating said end user using said first userID and said second password.

4. The method of claim 1, said method further comprising:
receiving said second userID from said end user, said receiving said second userID being in response to requesting said second userID from said end user, said requesting said second userID being in response to receiving said second key combination from said end user;
after said receiving said second userID, receiving said third password from said end user, said receiving said third password being in response to requesting said third password from said end user; and
authenticating said end user using said second userID and said third password.

5. The method of claim 1, said method further comprising:
incrementing a counter in response to said sending said error message to said end user, said counter being unique to said end user.

6. The method of claim 5, said method further comprising:
preventing said end user from authenticating for a period of time if the value of said counter exceeds the value of a threshold, said period of time being provided by an administrator prior to said receiving said first userID, the value of said threshold being a positive number greater than one and being provided by said administrator prior to said receiving said first userID, and
after said preventing, resetting the value of said counter to zero.

7. A computer program product, comprising a computer-usable storage medium having a computer-readable program code stored therein, said computer-readable program code containing instructions that when executed by a processor of a computer system implement a method for authenticating an end user, said method comprising:
receiving a first userID from an end user, said receiving said first userID being in response to requesting said first userID from said end user;
after said receiving said first userID, receiving a first password from said end user, said receiving said first password being in response to requesting said first password from said end user; and
sending an error message to said end user, said sending said error message being in response to failing to authenticate said end user using said first userID and said first password, said error message comprising a first option and a second option, said first option comprising a first key combination that if entered would allow said end user to enter a second password and authenticate using said first userID and said second password, said second option comprising a second key combination that if entered would allow said end user to enter a second userID and a third password and authenticate using said second UserID and said third password.

8. The computer program product of claim 7, said error message further comprising said first userID thereby identifying for said end user whether said first userID was entered properly by said end user.

9. The computer program product of claim 7, said method further comprising:
receiving said second password from said end user, said receiving said second password being in response to requesting said second password from said end user, said requesting said second password being in response to receiving said first key combination from said end user, and
authenticating said end user using said first userID and said second password.

10. The computer program product of claim 7, said method further comprising:
receiving said second userID from said end user, said receiving said second userID being in response to requesting said second userID from said end user, said requesting said second userID being in response to receiving said second key combination from said end user;
after said receiving said second userID, receiving said third password from said end user, said receiving said third password being in response to requesting said third password from said end user; and
authenticating said end user using said second userID and said third password.

11. The computer program product of claim 7, said method further comprising:
incrementing a counter in response to said sending said error message to said end user, said counter being unique to said end user.

12. The computer program product of claim 11, said method further comprising:
preventing said end user from authenticating for a period of time if the value of said counter exceeds the value of a threshold, said period of time being provided by an administrator prior to said receiving said first userID, the value of said threshold being a positive number greater than one and being provided by said administrator prior to said receiving said first userID, and
after said preventing, resetting the value of said counter to zero.

13. A computing system comprising a processor coupled to a computer-readable memory unit, said memory unit comprising a software application, said software application comprising instruction that when executed by said processor, implement a method for authenticating an end user, said method comprising:
receiving a first userID from an end user, said receiving said first userID being in response to requesting said first userID from said end user;
after said receiving said first userID, receiving a first password from said end user, said receiving said first password being in response to requesting said first password from said end user; and
sending an error message to said end user, said sending said error message being in response to failing to authenticate said end user using said first userID and said first password, said error message comprising a first option and a second option, said first option comprising a first key combination that if entered would allow said end user to enter a second password and authenticate using said first userID and said second password, said second option comprising a second key combination that if entered would allow said end user to enter a second userID and a third password and authenticate using said second UserID and said third password.

14. The computer system of claim 13, said error message further comprising said first userID thereby identifying for said end user whether said first userID was entered properly by said end user.

15. The computer system of claim 13, said method further comprising:
receiving said second password from said end user, said receiving said second password being in response to requesting said second password from said end user, said requesting said second password being in response to receiving said first key combination from said end user, and
authenticating said end user using said first userID and said second password.

16. The computer system of claim 13, said method further comprising:
receiving said second userID from said end user, said receiving said second userID being in response to requesting said second userID from said end user, said requesting said second userID being in response to receiving said second key combination from said end user;
after said receiving said second userID, receiving said third password from said end user, said receiving said third password being in response to requesting said third password from said end user; and
authenticating said end user using said second userID and said third password.

17. The computer system of claim 13, said method further comprising:
incrementing a counter in response to said sending said error message to said end user, said counter being unique to said end user.

18. The computer system of claim 17, said method further comprising:
preventing said end user from authenticating for a period of time if the value of said counter exceeds the value of a threshold, said period of time being provided by an administrator prior to said receiving said first userID, the value of said threshold being a positive number greater than one and being provided by said administrator prior to said receiving said first userID, and
after said preventing, resetting the value of said counter to zero.

19. A process for supporting computer infrastructure, said process comprising providing at least one support service for at least one of creating, integrating, hosting, maintaining, and deploying computer-readable code in a computing system, wherein said code in combination with the computing system is capable of implementing a method for authenticating an end user, said method comprising:
receiving a first userID from an end user, said receiving said first userID being in response to requesting said first userID from said end user;
after said receiving said first userID, receiving a first password from said end user, said receiving said first password being in response to requesting said first password from said end user; and
sending an error message to said end user, said sending said error message being in response to failing to authenticate said end user using said first userID and said first password, said error message comprising a first option and a second option, said first option comprising a first key combination that if entered would allow said end user to enter a second password and authenticate using said first userID and said second password, said second option comprising a second key combination that if entered would allow said end user to enter a second userID and a third password and authenticate using said second UserID and said third password.

20. The process for supporting computer infrastructure of claim 19, said error message further comprising said first userID thereby identifying for said end user whether said first userID was entered properly by said end user.

21. The process for supporting computer infrastructure of claim 19, said method further comprising:
receiving said second password from said end user, said receiving said second password being in response to requesting said second password from said end user, said requesting said second password being in response to receiving said first key combination from said end user, and
authenticating said end user using said first userID and said second password.

22. The process for supporting computer infrastructure of claim 19, said method further comprising:
receiving said second userID from said end user, said receiving said second userID being in response to requesting said second userID from said end user, said requesting said second userID being in response to receiving said second key combination from said end user;
after said receiving said second userID, receiving said third password from said end user, said receiving said third password being in response to requesting said third password from said end user; and
authenticating said end user using said second userID and said third password.

23. The process for supporting computer infrastructure of claim 19, said method further comprising:
incrementing a counter in response to said sending said error message to said end user, said counter being unique to said end user.

24. The process for supporting computer infrastructure of claim 23, said method further comprising:
preventing said end user from authenticating for a period of time if the value of said counter exceeds the value of a threshold, said period of time being provided by an administrator prior to said receiving said first userID, the value of said threshold being a positive number greater than one and being provided by said administrator prior to said receiving said first userID, and
after said preventing, resetting the value of said counter to zero.
